(19) United States
(12) Patent Application Publication
(10) Pub. No.: US 2018/0068386 A1
(43) Pub. Date: Mar. 8, 2018

(54) MODELING OPTION PRICES IN A DISTRIBUTED COMPUTING SYSTEM

(71) Applicant: Morris Donald Scott PUMA, San Francisco, CA (US)

(72) Inventor: Morris Donald Scott PUMA, San Francisco, CA (US)

(21) Appl. No.: 15/489,726

(22) Filed: Apr. 17, 2017

Related U.S. Application Data
(63) Continuation-in-part of application No. 15/272,378, filed on Sep. 21, 2016.
Application No. 15/272,378 is a continuation-in-part of application No. 14/540,035, filed on Nov. 12, 2014, now abandoned.
Application No. 14/540,035 is a continuation-in-part of application No. 14/312,662, filed on Jun. 23, 2014, now abandoned.
(60) Provisional application No. 61/902,758, filed on Nov. 11, 2013.
(60) Provisional application No. 61/902,760, filed on Nov. 11, 2013.
(60) Provisional application No. 61/837,634, filed on Jun. 21, 2013.
(60) Provisional application No. 62/323,571, filed on Apr. 15, 2016.
(60) Provisional application No. 62/337,394, filed on May 17, 2016.
(60) Provisional application No. 62/337,407, filed on May 17, 2016.

(51) Int. Cl. G06Q 40/04; G06Q 40/06

(52) U.S. Cl. CPC G06Q 40/04; G06Q 40/06

(57) ABSTRACT

Techniques to provide option traders with new insight in real-time, which helps them choose which options to buy and sell with greater accuracy in only a few seconds.

### CROSS-REFERENCE TO RELATED PATENT APPLICATIONS

This patent application claims the benefit of priority as a continuation-in-part of U.S. patent application Ser. No. 14/540,035, filed on Nov. 12, 2014 by Morris Puma, U.S. Patent Application No. 61/902,758, filed on Nov. 11, 2013 by Morris Puma, and also claims the benefit of priority of U.S. Patent Application No. 62/323,571, filed on Apr. 15, 2016 by Morris Puma, U.S. Patent Application No. 62/337,407, filed on May 17, 2016 by Morris Puma, and U.S. Patent Application No. 62/337,394, filed on May 17, 2016 by Morris Puma, the contents of each being hereby incorporated by reference in their entirety.

### FIELD OF THE DISCLOSURE

The invention relates generally to computer applications, and more specifically, to computer modeling of option prices in a distributed computing system.

### BACKGROUND OF DISCLOSURE

Options are complex and their price changes are affected by so many aspects such as time, volatility, price moves, interest rates, liquidity, pending news, etc. Current computer software does not display statistical information in a quick and user friendly manner for brokers and ordinary traders.

Therefore, it is desirable to overcome these shortcomings.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1.1 is a price chart of the underlying asset.

FIG. 1.2 charts the changes in IV or price of every option relative to the price range chosen by the user in FIG. 1.

FIG. 1.2 is a trend view chart of each option's implied volatility of a user's live or hypothetical options' positions with a new design that allows a user to revert the IV of any or all options quickly, simply and accurately, according to one embodiment. See FIG. 6 of U.S. Patent Application No. 61/902,758.

FIG. 1.3 is a heat map style output for user to view multiple months simultaneously.

FIG. 2.1 is a trend view chart of each option's implied volatility of a user's live or hypothetical options' positions with a new design that allows a user to revert the IV of any or all options quickly, simply and accurately, according to one embodiment.

FIG. 2.2 is a smile chart view instead of a historical trend view, according to one embodiment. See FIG. 6 of U.S. Patent Application No. 61/902,758.

FIG. 3.1 according to one embodiment, is a Risk Profile chart that uses an options pricing model to display “what if” scenarios for a single or plurality of options, stock, ETFs, futures or other similar trading products.

FIG. 3.2, according to one embodiment, is an example of another synched chart as this is a multi-chart application. 1B depicts V Wave™, which is proprietary volatility skew formula.

FIG. 3.3, according to one embodiment, is an example of a price chart also in synch with the other charts to give the user perspective of how the underlying price is moving relative to the attributes user is displaying on the other charts.

FIG. 3.4, according to one embodiment, is an example of another synched chart, this one being the profit and loss equity curve of the position. The user can see how the profit and loss was affected by the option Greeks, volatility, price changes, etc., according to user's selected charts.

### DETAILED DESCRIPTION

### I. Charting IV (Implied Volatility) and Price Changes of Options for Specific Price Changes and Ranges of Time of an Underlying Asset

Options are complex and their price changes are affected by so many aspects such as time, volatility, price moves, interest rates, liquidity, pending news, etc. Current computer software does not display the changes in options' prices, volatility or other option attributes through the passage of time effectively. Since this information is not shown to traders, they are at a disadvantage when they buy and sell options.

For example, a trader may want to make a profit in a bullish market and they purchase call options to do this. However, there are thousands of call options to choose from for an underlying asset. The trader can choose from call options that expire in one day all the way out to 3 years. The trader also can choose from deltas ranging from nearly 0 to 100. On SPX for example, there are thousands of options to choose from at any given moment. How can an option trader choose the options that will benefit the most if their “what if” scenario occurs and how can they lose the least when their “what if” does not? The current method used to determine which option to buy or sell of 8,000 possible options is to create 8,000 individual charts and model time, IV changes and price changes using an options pricing model such as the Black Scholes. To do this much modeling would take over 600 hours and would not be accurate.

Currently, choosing the best option is a guessing game because traders do not have the computerized tools and information they need. Therefore, it is desirable to overcome these shortcomings.

The above-mentioned shortcomings are addressed with methods, computer apparatus, and non-transitory computer-readable media providing option traders with new insight in real-time, which helps them choose which options to buy and sell with greater accuracy in only a few seconds.

In an embodiment, an options server communicates through a network with remote clients to provide options-related services. The options server comprises: 1. a memory storing a database with price charts of underlying assets; 2. a processor executing to display user interface panel for users to select one or more expiration cycles of options; and 3. the processor executing to display a user interface showing charts to illustrate changes of the option attributes relative to the underlying's price changes over a duration of time and options' expiration cycle chosen by user. In other words, the options server automatically generates the charts responsive to changes in time selected by a user.

Advantageously, incredible amount of information in seconds in an effective format. Although options are extremely complex, at the end of the day it all comes down to how the price of each option changes over time, relative to the changes in the underlying asset. Now, with this disclosure, a trader can clearly and quickly see which options to buy and sell to construct an effective options spread. A user can pair an option that loses money with another option that makes money.

In another embodiment, a user can see short term opportunities very easily from the processing results of the options server. If the underlying makes a fast move, there will usually be a skew that occurs. A user can quickly locate which options increased in price the most or where IV spikes are located. User can sell these options and buy others that are not so over-valued. Once the mean reversion occurs, the trader can make a profit.

An option trader can also use the options server output to study the possible future behavior of a spread. For example, if a trader wants to determine the best location to buy and sell options for a month cycle 60 days out, and the user plans to hold the position for 30 days, then the user can look at a 30-day month cycle and look back 30 days to study the behavior of the entire option chain in seconds. This method helps the user model the future 30 days of the 60-day cycle if the price-action of the underlying remains in a similar pattern. By the design of the current technique, users can also utilize other expiration cycles and select different price changes to create future modeling for their specific forecasted price move and specific options maturity (e.g., days to expiration). This is helpful if a trader wants to apply a specific price change or IV change to the future “what if” scenario. The current technique provides user flexibility to study the behavior of any options cycle over any price change as well as any duration of time.

In another embodiment, implied volatility (IV) per strike and price changes per strike are utilized. Option attribute changes can be viewed, such as but not limited to delta, theta, vega, gamma, vomma, vanna, veta, charm, etc. As mentioned earlier, since the bottom line is price change, and IV change (another form of price), we reduced the invention to price and IV change charts.

There can be two or more outputs for the charts. Users can view actual numerical changes or % changes. User can even see rank changes, not shown in diagrams.

One benefit of this disclosure allows the user to quickly create empirical data from “real option behavior” instead of modeling. Users can also see behaviors of the entire option chain at the same time, giving excellent perspective to the user.

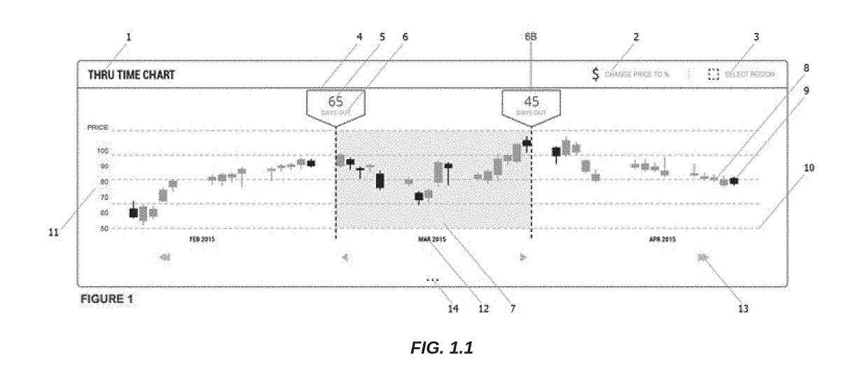

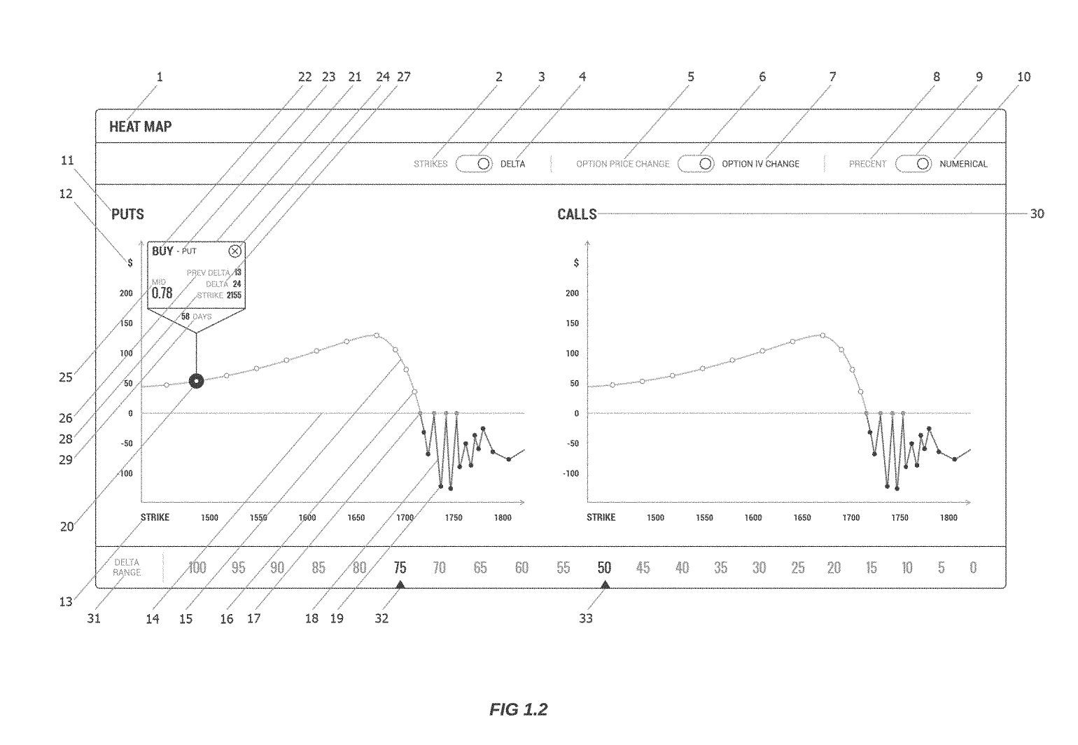

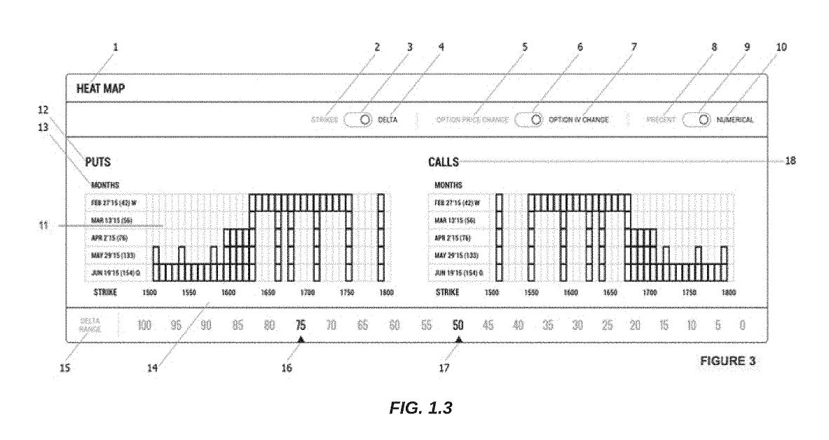

FIG. 1.1

FIG. 1.1 is a price chart of the underlying asset. By default, the chart will only go back in time as far as the chosen expiration cycle of options has existed.

1. Title of chart

2. Button for user to change view from actual price changes to a percent change chart.

3. Button for user to select a region or zoom chart.

4. Info box that acts as a grabber for user to choose the beginning of the price range to be tested.

5, 6. Displays how many days remaining until expiration.

6B. Info and grabber for user to select ending day of price range to be tested.

7. Highlights entire region that is chosen for testing by user. The time, IV changes and price changes are all applied to each option on a chart below so user can see how the options changed during time period chosen.

8, 9. Price chart of underlying asset.

10. Design element.

11. Y axis can be price of underlying or percent change of underlying.

12. Time and date is on X axis.

13. Navigation buttons to move chart left and right.

14. Grabber for user to resize height of chart.

FIG. 1.2

FIG. 1.2 charts the changes in IV or price of every option relative to the price range chosen by the user in FIG. 1.1. The month(s) plotted are also chosen by the user with my month optimizer panel. User can view puts, calls, puts and calls, single or multiple months. User can quickly and effectively see exactly how all options change relative to each other. User will see some options may lose value while others make value at the same time. This provides the user with excellent spread design opportunities and insight. User can see changes for any time period, from 1 second (providing data is available) up to the entire duration the option cycle existed.

1. Label for chart.

2. Label for button.

3. Button for user to toggle between delta or strikes on X axis.

4. Label for button.

5, 6, 7. Button for user to toggle between price change or IV change on the Y axis.

8, 9, 10. Button for user to toggle between percent or numerical changes on Y axis. Note, we could add Rank view here too.

11. Put label for chart.

12. Label for Y axis. In this example we plot changes in IV for each option.

13. Strike label for chart.

14. 0 line, which represents no change occurred.

15-19. Line chart which plots changes in IV or Price per option according to user's settings.

20. Indicator for position held by user. The invention plots user's trades on the charts.

21-29. Info box that follows cursor to display all relevant information about each option contract. User can build trades from this chart if they wish also by clicking info box.

30. Label for call chart.

31. Delta range controller. User can change which options appear on charts by selecting a delta range.

32, 33. User selects high and low delta range they wish to see on charts.

FIG. 1.3

FIG. 1.3 is a heat map style output for user to view multiple months simultaneously. The invention could also show line charts or other styles; this is just one example.

Note, info box from FIG. 1.2 shown in 22-29 can also be used for this view. Not shown in FIG. 1.3.

1. Label for chart.

2. Label for button.

3. Button for user to toggle between delta or strikes on X axis.

4. Label for button.

5, 6, 7. Button for user to toggle between price change or IV change on the Y axis.

8, 9, 10. Button for user to toggle between percent or numerical changes on Y axis. Note, we could add Rank view here too.

11. Different colors to indicate high, medium and low levels of IV and Price for each option.

12. Label Puts for chart.

13. Months on Y axis.

14. Strikes on X axis.

15. Delta range controller. User can change which options appear on charts by selecting a delta range.

16, 17. User selects high and low delta range they wish to see on charts.

18. Label for Call chart.

### II. Modeling Changes in Price, Time and Implied Volatility for Options, and Correcting Skewed Option Greeks, Profits, Losses, Account Values and Margins

Modeling changes in time, price and IV of options has been a challenge for decades for option traders. Option traders rely on the accuracy of modeling to determine potential risks, profits and losses. Accurate modeling is needed to determine the true options position and if said position should be modified by entering into new positions or closing existing positions. Accurate modeling methods are very valuable, and current modeling can be improved.

Often times, option pricing becomes skewed when the option price executes above or below the MID price on the options exchange. When this happens, the option Greeks are skewed, which the option trader relies on to manage their portfolio. When said Greeks are skewed, the trader's ability to manage the portfolio is frustrated and at times becomes impossible, because option Greeks can be off by thousands of points. For example, a Delta value could be 10,000, when it should be −1,000. A misleading Delta value could cause the trader to mismanage his or her positions. Thus, the options trader cannot make intelligent trading decisions related to managing his or her options portfolio when these skews present themselves.

Traditionally, an option trader will look at a price chart of an underlying asset and its implied volatility chart to estimate how volatility and price may change in the future. The most common implied volatility chart is 30-Day based, and it's created by an average of calls and puts 30 days to expiration, using various formulas.

With traditional modeling methods, a trader can input a change of time, price and implied volatility of the underlying asset into an options pricing model such as the Black Scholes to create various “what if” scenarios that are displayed through a risk profile chart. The challenge is to get the “what if” calculations as close to reality as possible.

The traditional method of modeling can be improved. The implied volatility of individual options does not necessarily follow the implied volatility of the underlying asset. Therefore, that method of modeling has its shortcomings and limitations.

When a price skew occurs on an option within a portfolio, profits and losses are skewed. On a large position a single skew can represent millions of dollars. It's possible for an account to receive a margin call due to a price skew. The invention provides a new method to correct price skews, profit and loss skews and net liquidation skews of trading accounts, and it could be automated and used by brokers as a method of margin calculations and account values. To overcome the shortcomings of the prior art, users are provided with a simple interface, to revert implied volatility of each option back to its mean or any previous level it was at before by grabbing its respective IV and dragging it to an IV of a previous date. This method of modeling mean reversion could be more precise than the current method used today. Advantageously, the techniques correct price skews, profit and loss skews and net liquidation skews of trading accounts, and can be automated for use by brokers as a method of margin calculations and account values.

1.

In another embodiment, the techniques herein correct IV skews per option, which in turn can correct option Greeks, profits, losses, account values and margins. IV changes per option can be modeled. IV mean reversion per strike is used in one non-limiting example. Many IV change models are possible.

Each option's individual and unique IV is reverted instead of reverting the IV of the underlying, which uses an options pricing model to determine IV changes of each option instead of using actual IV changes of each option as the invention does. Using a pricing model is very general and not necessarily correlated to the individual options the user is modeling.

It could be erroneous to model IV changes using the underlying's IV since IV charts are traditionally designed around a 30-day expiration cycle. For example, if a user's options are 300-Days out to expiration, then their IV behavior will be very different than 30-Days out to expiration. The invention allows the user to revert the IV of the exact options individually and easily for greater accuracy.

Although some software has IV charts for 30, 60, 90 days, etc., it's still not as precise as modeling the IV of each option's individual and unique IV. Thus, the invention is much more precise.

In one embodiment, the techniques model potential IV changes of an earnings release. Just before earnings are announced, there is usually a large increase in IV for options. However, the IV of every option does not increase the same. Sometimes, the IV increases more out of the money (OTM). Sometimes the IV increases more in the money (ITM) or at the money (ATM). If one models potential IV reversion using an options pricing model, the modeling will most likely be inaccurate since it will not be able to locate the different skews OTM, ATM or ITM.

The invention can be used to model IV reversion for every option contract independently and very precisely. If the (OTM) option IV is more inflated than the (ITM) option IV, the invention will recognize this and revert IV for each option accordingly.

Finally, by applying a previous IV to each option, the user is able to model a change in IV that may be more likely to occur. The invention allows the user to maintain the IV relationship between the contracts and to continue the pattern they have established, when an options pricing model would change their relative behavior.

The traditional modeling method could completely change the relative IV between the option contracts, creating modeling problems by implementing an unnatural change in IV for each option.

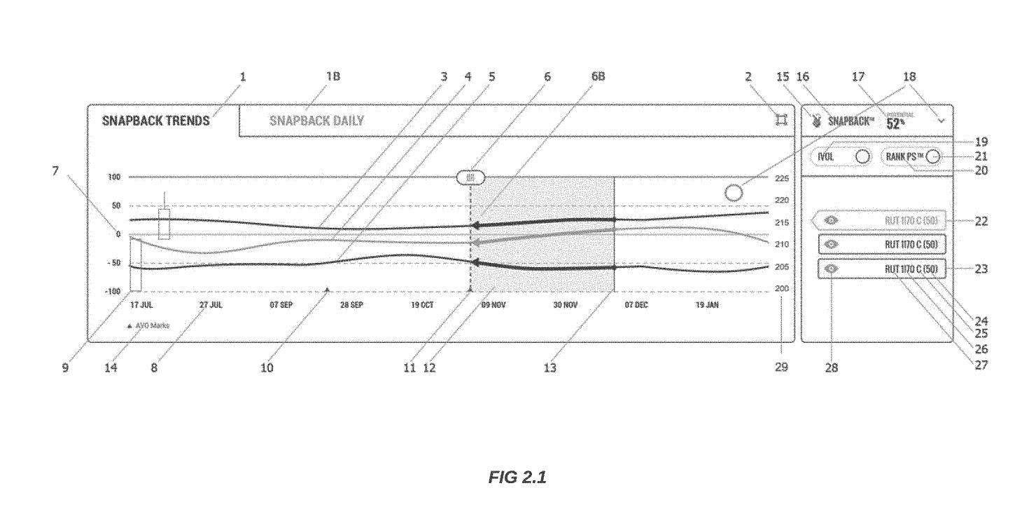

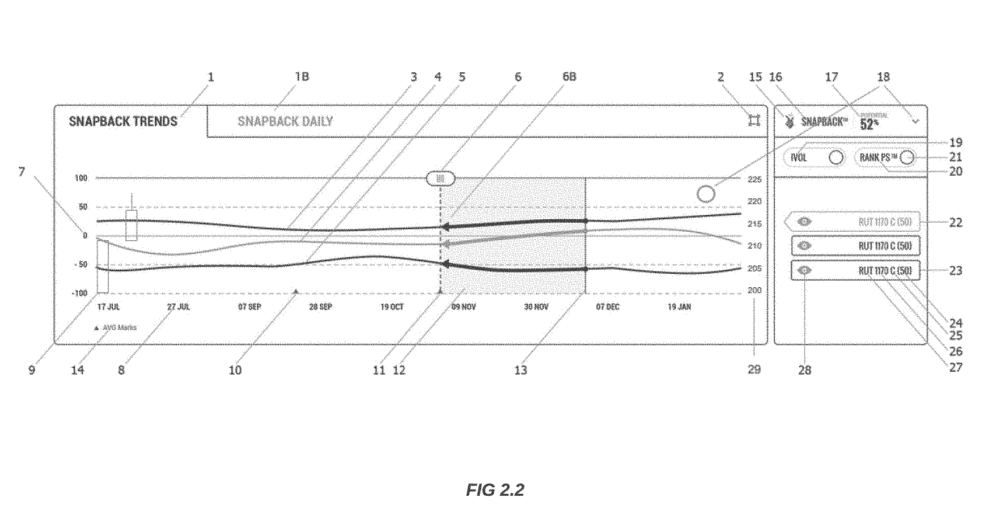

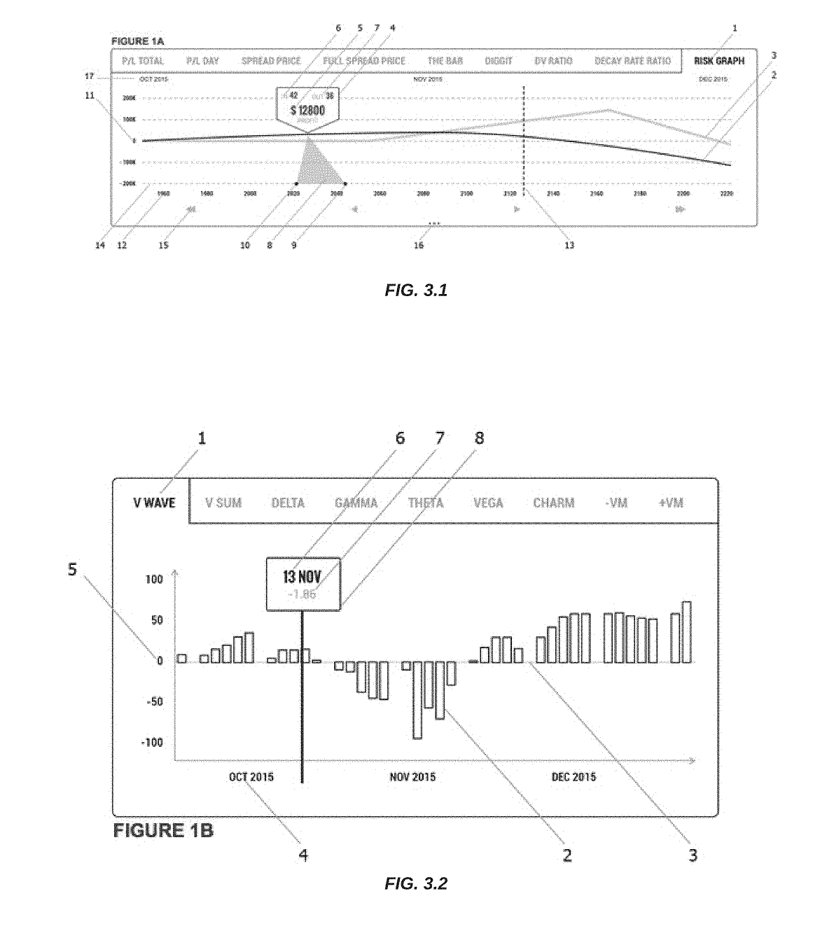

FIG. 2.1

FIG. 2.1 is a trend view chart of each option's implied volatility of a user's live or hypothetical options' positions with a new design that allows a user to revert the IV of any or all options quickly, simply and accurately—a new method of modeling IV and price changes of options.

One aspect adds a grabber as part of the chart for user to drag to any time in the past. The number of IV points would be determined by the historical data provided. For example, the IV points could be end-of-day, hourly or by the second, etc.

As the user moves the grabber to a time in the past, the current IV of each option is changed to the new, selected IV of each option from its past. Simultaneously, the change in IV for each option is input into an option pricing model, and each option price is calculated with the new IV at the chosen date, price and underlying IV of the user. This action will update the risk profile, profit and loss, Greeks, and all relevant information pertaining to user's trade.

As noted earlier, a broker could also use this method to calculate margins and account values when they are skewed, providing a safer trading environment for all parties.

Sometimes one option strike or more can be skewed. When this happens, Greeks and profits or losses are distorted. The invention gives the user a simple way to correct this information, so the user can make better trading decisions.

In addition to reverting the IV of all options to a date in the past, the user can simultaneously fast-forward time to the future using an options pricing model. The invention provides the user with a new way to model current or future options positions based on unique historical IVs of each option's past.

Also, a user can change the IV of the underlying product simultaneously as reverting individual option's IV to the past. This could be helpful to first correct any skews between the options and then to change the IV of all options together after repairing said skew. It gives the user a multi-dimensional method to model IV changes and to correct IV skews in only seconds.

In addition to the above, the user can also model a change in price of the underlying simultaneously as reverting each option's IV to the past.

In summary, a user can revert a single or plurality of options to their respective past IVs, and at the same time the user can model changes in time, price and IV of the underlying asset. User can correct IV and price skews using this invention, which repair distorted profits and losses and option Greeks. Brokers can use this invention to calculate account balances and margins, repairing those skews as well, increasing safety for all parties. Embodiments could be automated or manual.

More specifically, FIG. 2.1 shows:

1. Label for tab which contains a historical trend chart of each option's IV with a price chart of the underlying superimposed behind it. A potential name for this is Snapback™ Trends.

1B. Label for other chart which displays current IV of each option, numerical or Ranked Per Strike™. This chart shown in FIG. 6C.

2. Button for user to pop out chart to new window if they wish.

3, 4, 5. Represent implied volatility (IV) charts for every option of user's positions.

6. Grabber used to revert IV of each option to its past IV as a group.

6B. Drag-and-drop Arrow. User could also grab each arrow to change IV of each option individually.

7. Y-Axis shows IV level. Note, when on IV Rank Per Strike™, level can be negative since it's a ranking system. Charts can be ranked charts or numerical charts. Ranking IV of each strike is part of SJO-002, Application Number 14540035.

8. X-Axis shows the date or time if during a live market.

9. A price chart can be superimposed onto the IV charts for additional information.

10. A mark such as a triangle can be used to indicate “average IV points” in case user wants to revert to the mean, calculated by the application.

11. The point in time where each option's IV is being reverted to by the user.

12. Colored area shows originating IV of each option and where to IV is being reverted for said options.

13. Shows starting IV of each option.

14. Legend to indicate “average IV points”. These are points in time where the overall IV of all options was at an average—a proprietary calculation of the application.

15. Icon for visual effect.

16. Snapback™ is the potential name of the invention.

17. The invention instantly calculates the potential profit or loss of the options positions based on the IV changes of each option's IV. A click toggles from percentage to dollar amount.

18. User can display or hide “modeled price change”. As user changes price of underlying product input into the options pricing model, an icon appears on the price chart for reference of said price change.

19. User can view IV trend charts, but user can also see Price trend charts of each option by clicking button.

20. Rank Per Strike™ is potential title for ranking IV of every option.

21. User can view Numerical IV or IV Rank Per Strike™ of each contract. The ranked view will display skewed IVs to the user. When the IVs are not skewed, the chart will form a single IV line on this setting. When skews are present, the user will see multiple lines, displaying over and under-valued IVs of each option.

22. Information outputs combined as navigation buttons containing pertinent information about each option. Arrow pointed to left indicates user is hovering mouse over a line.

23, 24, 25, 26, 27. Show details for each option such as underlying symbol, strike, call or put, days to expire, etc.

28. Button to hide and show each IV or Price line on the chart.

29. Axis for price chart of underlying asset.

FIG. 2.2

FIG. 2.2 is a smile chart view instead of a historical trend view. This chart allows the user additional functionality of the same invention. Here, the user can see the “mean” of each option's IV for a selected loopback period of time, and where the IV currently relative its mean. User can grab each IV and revert it to its mean partially, entirely or move IV farther away if they wish. This is very handy when a strike is skewed and a user needs to repair skewed Greeks, profits and losses of an options position. As previously stated, when an option price or its respective IV is skewed, option Greeks, profits, losses, account balances and account margins are skewed too, and the user and broker are displayed skewed information. The invention offers a solution to this problem.

In addition to displaying the mean of each individual option's IV, some embodiments calculate and display the “IV mean” of the exact month cycle of user's options. Users can revert the entire month back to its mean or move it away if they wish to model that as well for more advanced modeling.

Finally, user can change the loopback period, which allows short-term or long-term skew modeling.

In more detail, FIG. 2.2 shows:

1. Tab indicates Snapback™ Daily, a possible name for this design.

2. Button used to pop out panel to new window.

3. User selects loopback period for ranking and mean calculations.

4. Buttons not selected are different color.

5. Visual bar represents an Option Strike is located there.

6, 7. Indicate “mean” of each option's IV, according to user settings. Colors are unique for each month. Example shows 2 months.

8. IV Smile chart in numerical or Rank Per Strike™ form.

9. IV Smile chart of second month if selected by user.

10. Bordered circle indicates short contract. Location shows its IV value. User can grab and move each option's IV or price using icon.

11. Solid circle indicates long contract. User can grab and move option's IV or price using icon.

12. Y axis is for value or ranking of each option's IV.

13. Strike prices of each option.

14. Design element.

15. Slider shows month's IV value or rank. User can grab and move IV or entire month up or down, which will change all individual option's IV and price together.

16. Dash line within element shows IV mean for entire month according to user-selected loopback period.

17. Options expiration cycle information.

18. Days remaining for options expiration cycle.

19. Icon, design element.

20. Snapback™ is possible name of the invention.

21. The invention instantly calculates profit and loss potential of the options positions based on the IV or price changes input by user, but IV reversion potential profit and losses can also be generated automatically for the user in another embodiment. An exact dollar amount or percentage based on margins is calculated for user.

22. This icon is used in FIG. 6B.

23. User can display each option's IV, but user can also see each option's price with this toggle button.

24. Rank PS™ (Rank Per Strike) is a possible title for ranking IV of every option.

25. User can view numerical IV or Ranked IV of each contract. The ranked view will show user different information. When skews do not exist, each IV when ranked, would form a perfect, horizontal line if the mean is drawn in the center of the chart. However, when skews present themselves, the ranking system will show over and under-valued IVs of each option as they spread apart on this view.

26. Arrow pointed to left shows user is hovering mouse over line.

27, 28, 29, 30, 31. Show details for each option.

32. Hide and show each option's IV chart or price chart.

### III. Visual Timeline of Past, Current and Potential Option Positions and their Attributes

Options are complex and their price changes are affected by so many aspects such as time, volatility, price moves, interest rates, liquidity, pending news, etc. Current computer software does not display the changes in options' prices, volatility or other option attributes through the passage of time effectively. Since this information is not shown to traders, they are at a disadvantage when they buy and sell options.

For example, a trader may want to make a profit in a bullish market and they purchase call options to do this. However, there are thousands of call options to choose from for an underlying asset. The trader can choose from call options that expire in one day all the way out to 3 years. The trader also can choose from deltas ranging from nearly 0 to 100. On SPX for example, there are approximately eight thousand options to choose from at any given moment. How can an option trader choose the options that will benefit the most if their “what if” scenario occurs and how can they lose the least when their “what if” does not? The current method used to determine which option to buy or sell of 8,000 possible options is to create 8,000 individual charts and model time, IV changes and price changes using an options pricing model such as the Black Scholes. To do this much modeling would take over 600 hours and would not be accurate.

Currently, choosing the best option is a guessing game because traders do not have the computerized tools and information they need. Therefore, it is desirable to overcome these shortcomings.

The above-mentioned shortcomings are addressed with methods, computer apparatus, and non-transitory computer-readable media providing option traders with new insight in real-time, which helps them choose which options to buy and sell with greater accuracy in only a few seconds.

In an embodiment, charts of all internal attributes of any options spread or a single option contract are provided to a trader, similar to watching how a glass engine would run. To this wend, a trader is able to view all Greeks of a trade, in some embodiments, first order and higher order Greeks as well as formulas created between Greeks. Volatility formulas such as skews, sums and ratios can also be displayed. Volume and open interest are other optional displays. Many other charting variations are possible in which a trader is shown how an option attribute changes relative to time, price and volatility changes of the underlying asset.

In another embodiment, option attributes can be, but are not limited to: delta, gamma, theta, vega, vomma, vanna, veta, lambda, charm, speed, color, implied volatility, volatility skew, implied volatility rank per Strike™, profit and losses, spread price, single option price, ratios between Greeks, risk profile, price moves of the underlying, implied and historical IV of an underlying and anything else related to an option trade. This information can be used to review past trades, current trades, to combine live trades with potential trades and to enter into new trades and exit trades with greater precision. For example, since volatility is such an important part of options trading, a user can track the volatility skews of the options of their entire spread on a chart. This chart can give the user greater insight on when to enter, exit or adjust the trade.

Another example is the user can instantly view all past volatility or profit and losses of any spread dynamically and animated, as the changes occurred through time. A user can also see how much any spread price has changed for a day, during a live market, or see the spread changes since the spread first existed. Currently, traders enter and exit trades without this internal information. Advantageously, the disclosure herein allows traders to time trades much more precisely.

Often times option prices will become skewed, causing profits or losses that do not reflect reality. Users can be shown exactly why the skew has occurred for better understanding of the situation and guidance on whether to take necessary action or not.

In still other embodiments, users can review past trades. Quickly and effortlessly a trader can see all adjustments, see a “replay” of the trade including an animated risk profile. Users can also track trades they have not taken and wait to enter into them with great precision. The entire trade history of any trade can be tracked, so a user can enter into a trade at an improved price or improved volatility skew.

Traders can combine live trades with potential trades to improve volatility mean reversion probabilities, increasing profit potential. Traders can also quickly identify when mean reversion has been captured and it's time to exit. Traditional software has a volatility chart of the underlying asset but does not track volatility of each option like the current techniques.

Advantageously, a vast amount of information in seconds in an effective format. Although options are extremely complex, at the end of the day it all comes down to how the price of each option changes over time, relative to the changes in the underlying asset.

Now, with this disclosure, a trader can clearly and quickly see which options to buy and sell to construct an effective options spread. A user can pair an option that loses money with another option that makes money.

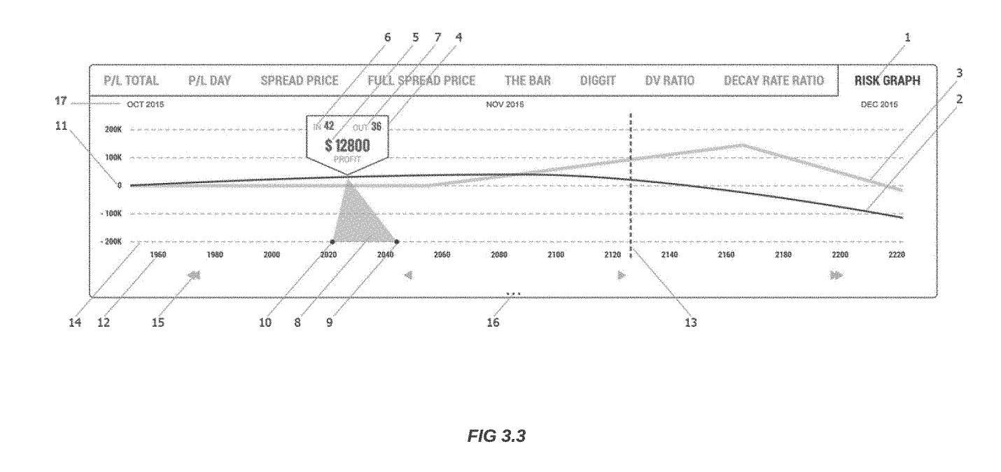

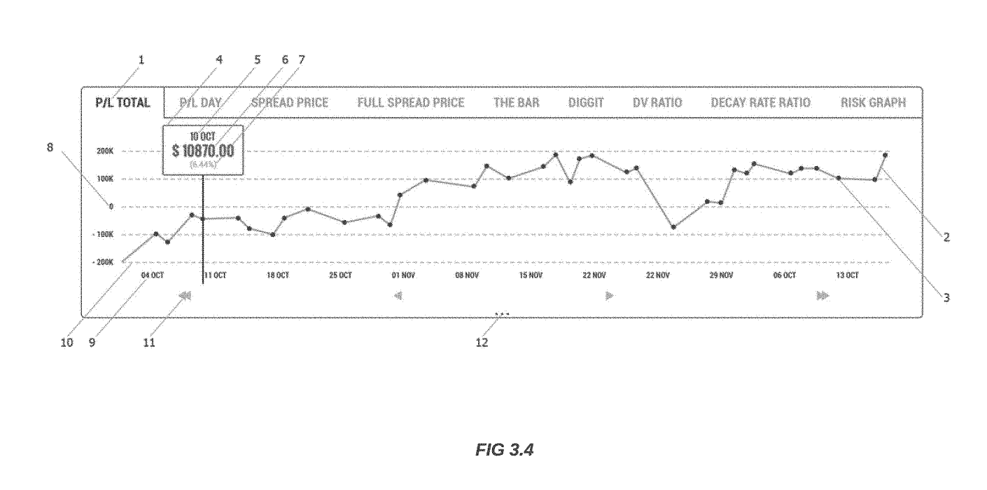

In one embodiment, FIGS. 3.1, 3.2, 3.3, 3.4 are displayed simultaneously in multiple charts and in synch, so as user moves the mouse across one chart, the cursor moves across all other charts in unison. This allows the user to see how all the moving parts of their positions change relative to each other and how they interact together through changes in time, price and volatility, like a glass engine. There are many moving parts of an options' position, but some include: underlying price changes, option price changes, IV changes, IV skew changes, volume changes, option Greek changes, etc. The invention can be designed such that a user can select and display numerous types of charts related to option trading.

All charts are interactive and dynamically animate with the user's movements. With this design, a user has endless possibilities to view rich information and watch the relative behavior between the moving parts, in a very simple format.

In one embodiment as example, a user may wish to design an options position with a Vega that dynamically follows the volatility of the underlying, meaning Vega increases with a rise in IV and Vega drops with a decrease in IV. Thus, the user designs a trade with a positive Vomma position, which would theoretically do this. After the user configures the options trade with positive Vomma, then the user moves the cursor over a period of time where IV changes abruptly, and at the same time, the user watches how the Vega position changes over said IV changes. Since Vomma represents how Vega changes relative IV changes, this would be a fast and visual way to test a Vomma configuration. The user can continue to modify the trade structure until the Vega position behaves how the user expects it to. In only a few minutes, a user can create a dynamically, self-adjusting Vega position using this invention.

FIG. 3.1

This is one chart of a multi-chart view. Each chart can be in synch with each other. As user moves cursor inside one chart, a synchronized cursor moves in each chart, so user can visualize multiple attributes of their trades and how they relate to each other over time, price moves and volatility changes.

FIG. 3.1 has many charts user can tab through. There can be various types and amounts of tabs and users can modify as needed. In the diagram we see an interactive risk profile, but this risk profile is different than traditional risk profiles. This risk profile “replays” the life of the user's trades that are selected by the user. User will select options, stock, futures and other financial instruments. In this example, we are looking at a spread created with options. As user moves cursor from left to right, the risk profile moves and replays the trade as it happened, advancing through time. User will see the risk profile move as it did over days or months, but they can review this in seconds.

If user is reviewing a trade that included adjustments, then user can see this information too. As user moves mouse from left to right, passing through time, the risk profile will change due to price, time, volatility and adjustments made. User can watch how they managed the trade. All critical information is displayed to user such as any and all Greeks, profit and losses, adjustments made, price changes, volatility changes and much more.

Another use for this chart is to review a potential trade. Although a potential trade will not include any trade history, a user can still review how the attributes of the trade reacted relative to time, volatility and price moves.

More specifically, the labels in FIG. 3.1 are described as follows:

1. These are tabs for user to switch between various charts. User can modify tabs as they wish. User could also choose more than one tab and view more charts simultaneously as needed.

2. This line represents the profit or loss at the corresponding price on the X axis.

3. This is the risk profile at expiration. It plots the profit and loss at the corresponding price on the X axis at expiration.

4. Info box follows cursor to show relevant information according to date of trade. Arrow at bottom shows closing price of the day.

5. Represents the profit or loss of trade for corresponding date, time, price, etc.

6. Represents number of days in the trade.

7. Represents number of days until trade expires.

8. Shows price range of underlying on that date.

9. Displays high price of the day for underlying product.

10. Displays low price of the day for underlying product.

11. Break even line of the trade. Above is profit and below is a loss.

12. Strike price and price of the underlying asset.

13. Represents date an adjustment was made to trade.

14. Profit and loss grid lines.

15. Navigation buttons for user to move chart left and right.

16. Grab icon for user to change chart height.

17. Date of trade on upper X axis.

FIG. 3.2

FIG. 3.2 is another chart in synch with other charts. In this example user can see various Greeks charts as they change through time, price changes and volatility changes, as well as when user makes adjustments to the trades. User can create custom formulas on these charts or follow traditional Greeks such as delta, gamma, theta and vega. Advanced Greeks can be viewed as well such as vomma, vanna, charm, lambda, veta and many others. −VM™, +VM™, V Wave™ and V Sum™ are my own, unique formulas.

When user moves the mouse, in some embodiments, the chart moves in synch with other charts, as user moves mouse left and right to fast forward and reverse time, watching how each part of the position behaves relative to each other. User can view one chart on this block, multiple charts and user can also add or subtract charts from a selection box, not shown. The charts are not limited to the links shown herein.

The V Wave™ is a calculation that tracks the volatility of any short strikes relative any long strikes of the option trade. Some trades will be ideal to begin when the V Wave™ is at the top of the trend. This is an example of using this chart. Another implementation would be to use the chart as an exit point. When the chart is low, profits have been made, and it could be a signal to exit.

1. Tabs are used to switch between various charts or to combine charts. Tabs can be modified by user. Any attribute of the trade can be displayed as it changes through time, price, volatility changes and adjustments made.

2. Represents a trend chart of the selected attribute.

3. Divider line which sits on the 0 mark.

4. Date of trade is on the X axis.

5. Values of attribute are shown on the Y axis.

6. Date is displayed as user moves cursor.

7. Value of attribute is displayed for date & time.

8. Info box that follows cursor in synch with all other charts.

FIG. 3.3

FIG. 3.3 is a synched chart with underlying price chart and volatility chart. These can be moved to any chart as needed.

1. Tabs for user to switch between charts or to combine charts.

2. Price chart shows price changes through time of underlying asset.

3. Info box follows cursor in synch with all other charts. Note, user can see price move in this chart while viewing how the price change impacted other internal attributes of the trade. It's like watching an engine run that is made of glass.

4. Date of trade or time stamp if during a live market.

5, 6, 7, 8. Open, Close, High, Low of underlying.

9. Price of underlying on Y axis.

10. Date or time on Y axis.

FIG. 3.4

FIG. 3.4 is another example of a synched chart. Since user can track the historical profit and loss of any trade, they can time their entry or exit better. This can be used during a live market.

1. Label of tab.

2. The profit and loss line of the trade through time.

3. Profit or loss at an exact time.

4. Info box follows cursor to show relevant information according to date of trade such as profit or loss, % profit or loss, date, etc.

5. Represents the corresponding date, time, price, etc.

6. Represents profit or loss at that time.

7. Represents % profit or loss at that time.

8. Break even line.

9. Time is on X axis.

10. Grid lines for profit or loss.

11. Navigation buttons to move chart left and right.

12. Grab icon to change height of chart.

### Computer Embodiments

The disclosure can be implemented in, for example, an options server computing device coupled to a computer network such as the Internet or other wide area network to allow connections from remotely connected user computing devices.

An options server is an apparatus that can include an implied volatility module, a price change module, and a user interface module, among other components, in electrical communication with processors, memory devices, network interface apparatus, and other components. The computing devices can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

In some embodiments, a set of rules is created and stored for implementing techniques described herein. The rules can be defined in source code, as higher level code, or even by entries from a user interface. These rules can allow one technology to improve another technology and are more than just manual steps performed by a computer.

Generalities of the Disclosure

More generally, the various features described in association with specific embodiments are non-limiting, as features can be interchanged between the embodiments if appropriate. As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies, data structures and other aspects are not mandatory or significant, and the mechanisms that implement the invention or its features may have different names, divisions and/or formats. The foregoing description, for purpose of explanation, has been described with reference to specific embodiments. However, the illustrative discussions above are not intended to be exhaustive or limiting to the precise forms disclosed. Many modifications and variations are possible in view of the above teachings. The embodiments were chosen and described in order to best explain relevant principles and their practical applications, to thereby enable others skilled in the art to best utilize various embodiments with or without various modifications as may be suited to the particular use contemplated.

1. A computer-implemented method for modeling options price, the method comprising:
storing a price history of underlying assets;
displaying a user interface for users to select one or more expiration cycles of options;
generating a chart to illustrate changes of option attributes relative to underlying price changes over a duration of time including the one or more expiration cycles; and
displaying the chart in the user interface.
